(19) United States
(12) Patent Application Publication
(10) Pub. No.: US 2021/0252957 A1
(43) Pub. Date: Aug. 19, 2021

(54) FOLDABLE, IMPACT RESISTANT APPARATUS FOR PROTECTING GLASS PANELS

(71) Applicants: Donald Swan, Whippany, NJ (US); Georghios Makris, Republic of Cyprus (CY)

(72) Inventors: Donald Swan, Whippany, NJ (US); Georghios Makris, Republic of Cyprus (CY)

(21) Appl. No.: 17/164,132

(22) Filed: Feb. 1, 2021

Related U.S. Application Data
(60) Provisional application No. 62/972,941, filed on Feb. 11, 2020.

(51) Int. Cl. B60J 11/08; E06B 5/10

(52) U.S. Cl. CPC B60J 11/08; E06B 5/10

(57) ABSTRACT

The present invention includes a foldable, impact resistant apparatus for protecting glass panels from projectile strikes. The object of this invention is to provide a unitary collapsible and foldable structure formed to provide impact protection to otherwise fragile glass of any window structure whether for a vehicle or a building. A further object is for the apparatus is to be easily deployed by a single person, easily folded away from the window structure or removed collapsed and folded for storage.

### CLAIM OF PRIORITY

This application claims priority to U.S. Provisional Patent Application Ser. 62/972,941 filed on Feb. 11, 2020, the contents of which is fully incorporated by reference in its entirety.

### FIELD OF INVENTION

This invention relates to protective glass covers for building structures and vehicles and more specifically to window glass protective covers for protecting the glass from strikes of projectiles.

### BACKGROUND OF INVENTION

Glass fracture and exposure of building interiors to the elements due to flying debris during hurricanes is one the most common source of damage to buildings. Temporary shielding applied to windows is the most common precautionary activity, but it is cumbersome time consuming and expensive. Solid shields are large and difficult to install. Flexible ballistic nylon sheet shields are functionally incapable of stopping the projectiles from fracturing the glass due to their inherent flexibility. Simple accordion type shields or retractable designs require additional dedicated structures to support their installation and typically require permanent installation of guide channels. Portability and ease of installation is critical to the use of these protective systems. Similarly, vehicle glass shields are used and have comparable problems of compact storage, effective deployment and portability.

A protective glass cover is an apparatus that is used to shield the glass panels from breaking. This protective cover, when deployed, forms an impact resisting barrier shielding the glass from fracture. Various techniques are used to achieve protection from flying objects such as hurricane debris, and most use solid panels to achieve the protection needed and some systems use accordion expandable type rigid panels and further some use high strength flexible sheathing stretched across the glass panels. All of these systems lack any one or all of either portability, rigidity, effective and easy deployment, footprint reduction for storage when not in use, etc.

Accordion type protective covers can be more compact but are also cumbersome to assemble and complex to deploy. Typically, these systems require directing and holding channels in permanent installation on the building structure or where portable the accordion structure in not effective in function compact storage and ease of deployment.

Several examples of portable vehicle protective covers are disclosed such as U.S. Pat. No. 6,044,881. U.S. Pat. Nos. 5,242,206, 5,401,074, 6,220,648 inflatable tubes, shock absorbing foams or other bulky materials to provide for the protection. These covers are mostly difficult to deploy or to refold and store or require additional assembly for deployment. U.S. Pat. Nos. 6,220,648, 5,242,206 5,413,396 employ the principle of setting up panels at an angular orientation to each other forming an accordion rigid cover and yet be foldable for storage. Such panels have accordion folds that extend the width of the vehicle and are reducible in the longitudinal direction of the vehicle thus presenting storage issue since they are typically wider than the vehicle and they will not fit in the trunk of a vehicle. This folding and storage issue have been addressed by U.S. Pat. No. 9,302,572 in one embodiment provides for a totally flexible truss made of cloth as a vehicle cover without rigidity towards impact protection. Also U.S. Pat. No. 9,302,572 in an alternate embodiment forms inner insert sleeves as parts of the accordion truss form and requires that support panels are individually inserted within these sleeves that consequently prohibit the cover foldability along the length of these panels. Thus, the accordion structure is flexible and foldable and made rigid only after each of the panels are individually assembled within pockets of the structure. This solution presents the requirement of total disassembly of the apparatus and individually folding of the panels in order to reduce the overall width of the apparatus prior to storage in a compact form. None of the prior art provide unitary truss construction of an impact resisting cover or for a unitary truss construction with foldability in a perpendicular direction to the truss form and clearly rely on several additional elements such as strings separate support panels and other separate construction elements that increase complexity of assembly, deployment as well as cost. U.S. Pat. No. 9,302,572 use of panel pockets and separate inserted support panels with hinges at intermediate points along the length of the panels clearly illustrates the an anticipated resolution by the present apparatus of the unmet foldability of any protective cover and particularly a cover that would for all intent and purposes is to be temporarily deployed to protect fragile structures and subsequently be easily removed and stored in a compact form for future reuse.

Other prior patents include, CN104527380B which teaches an apparatus for a driver's protection from glass fragments. It is not intended to protect the glass of the windshield; Spanish Patent ES1229090Y which teaches “rollup” interior shades and not exterior impact protection; U.S. Pat. No. 7,059,650B1 which teaches a flexible cover with features for secure attachment to the vehicle; U.S. Pat. No. 8,132,603B2 which teaches a flexible fabric shape for intimate sealing to maintain the dryness of a windshield rather than protect the windshield from impact; U.S. Pat. No. 8,430,445B1 which discloses a an impact resistant cover for protecting a vehicle windshield comprising: a plurality of spaced apart rectangular panels, the panels having a flexible, puncture resistant, covering, the covering enclosing a resilient material having a thickness of between 0.5 and 1.5 inches; and flexible webs permanently interconnecting the panels; the webs of such flexibility and extent as to enable the panels to lie in a common plane in a first selective positioning of the panels, and alternately to lie one panel atop the next panel in a vertically aligned stack of all of the panels, in a second selective positioning of the panels; US Patent Publication No. 20070284023A1 which discloses an inflatable structure and discloses accordion folding of deflated structure for storage; International Patent Publications WO2010073071A1 which teaches a fabric cover folded in accordion manner and features for vehicle attachment and WO2016092127A1 which teaches a canopy style fabric cover requiring frame and posts to support above vehicle.

The prior art does not solve the problem. Applicant is trying to solve. The prior art does not teach an accordion folding technique which comprises, accordion folding of rigid panels with a top and bottom flexible “fabric” and as accordion folding of diploid cover to better fit vehicle shape and a full accordion folding of collapsed cover for easier storage. Furthermore, although these protective cover apparatuses have protective capabilities, none of these either separately or in combination with each other, teach or anticipate the current invention. The effectiveness of the accordion concept is hereby acknowledged but the finished construction of the apparatus in forming a collapsible truss that can maintain rigidity on deployment is recognized to be critical in its ultimate effectiveness and use, footprint reduction for storage, to deployment and return to storage. Therefore, there remains an unmet need in the field of glass protective covers for a person to use to protect a glass window which is durable, be flexible for deployment and storage, and effective in preventing damage from flying solid objects. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

To resolve the problems mentioned above, an object of the present invention is to provide a protective cover that shields a window and other fragile surfaces from large flying objects during inclement weather events or other potential hazards such as ball strikes when a car is parked close to ball fields.

It is another object of the present invention to provide a protective window cover that is universal in dimension with a shape that conforms to the typical size and shape of a window, flat or curved such as a bay window or a car windshield.

It is another object of the present invention to provide a cover that provides the user with attachment methods to secure the cover to the window structure in a simple way while protection effectiveness remains without the need for high tensioning requirements of the apparatus or its elements.

It is another object of the present invention to provide a protective window cover that is light weight, foldable in both longitudinal and transverse directions into a compact form which by its unitary construction and material composition can be quickly and easily deployed and retrieved by an individual person.

It is another object of the present invention to provide a protective window cover which can be folded into a small unitary shape without disassembly of any of its structural elements for ease of storage.

It is yet another object of the present invention to provide a method of constructing a protective window cover that is light weight, foldable in both longitudinal and transverse directions into a compact form which by its unitary construction and material composition can be quickly and easily deployed and retrieved by an individual person.

It is yet another object of the present invention to provide a method of constructing a unitary protective cover that is comprised of rigid panels forming flexible accordion structure with flexible sheets on either side of the accordion structure such that when diploid form an impact resisting truss yet foldable in a direction perpendicular to the truss.

It is yet another object of the present invention to provide a method of constructing a unitary protective cover that when diploid forms an impact resisting truss yet foldable in a direction perpendicular to the truss and yet further foldable in a direction parallel to the truss.

It is yet another object of the present invention to provide a method of constructing a unitary protective cover by permanently affixing flexible sheets to both sides of a unitary accordion formation made by structurally rigid panels and flexible intermediate hinges integral to the rigid panels.

The present protective cover invention comprises, a top thin and flexible tension element, a bottom thin and flexible tension element and obliquely appositioned rigid elements positioned between the top and bottom elements in the manner of a Warren Truss in which oblique rigid elements form the truss by directly been attached to the flexible tension sheets to provide a thick structurally stable cushion, together resisting local compressive deformation normal to the tension elements and distributing the concentrated force of impact over an extended area avoiding glass fracture. The inability of the tension sheet to resist compression and the flexibility of the junction to the rigid elements permits the truss to conform to curvatures and additional collapse of the truss in a direction perpendicular to the truss rigid elements to a folded state intended for compact storage. The positioning of the oblique semi rigid elements and the flexibility of the tension sheets and hinged junction between rigid elements allows for the protective cover to conform to the fully extended position at the neighborhood of impact by spreading the semi rigid elements and placing the flexible sheets in full tension sustaining the spaced thickness of the protective cover, cushioning and distributing the impact over an extended area.

Advantageously, the cover comprises one or more sections having an one sited tension sheet and rigid element interruption (cut) along the width of the protective cover forming a hinge line at the uninterrupted opposing tension sheet and along the direction perpendicular to the semi rigid elements, permitting further folding of the cover in either the diploid or collapsed form. This permits the reduction of the overall length of the protective cover to allow convenient and compact storage. Each interruption is further repeated between the sections of the cover in alternate fashion permits the further reduction of the overall length by stacking the folded cover in the form of a parallel folding fan.

The present protective cover is provided with connection points for the purpose of fastening to the protected vehicle. These connection points utilize fasteners spaced along the foldable sides of the cover which can be laces, straps, suction cups, or otherwise secured when deployed and provide the user easy and simple use. The stability of the cover when attached to a bay window or the windshield of a vehicle is provided by the flexibility of the tension sheet that conforms to the convex shape of the windshield in convex form and in the windshield specific application the foldable cut sections conform to the acute angles the hood and roof of the vehicle forming a snug fit to the vehicle.

The top and bottom sheets are made of very flexible and of high tensile strength material such as fiber reinforced thin plastics, for instance polyethylene Polyester or HDPe, that provide adequate tensile strength to resist the tensile force generated by the oblique element of the truss formation at the time of impact. The oblique elements are made of solid, corrugated or laminate construction to reduce weight and increase axial buckling stiffness and of similar materials to the sheets. The sheets are flexibly and permanently connected to the oblique elements by flexible permanent adhesive. Alternatively, the materials used for the oblique elements and sheets may be fusibly compatible so as to fuse together by melting provide strong and adhesive free connection of the components at their construction intersections. Several additional assembly and construction methods of forming the unitary cover elements are anticipated with examples of manufacturing by over molding, single extrusion, co extrusion, thermoforming individually and in combinations of these methods.

One alternate construction method for example utilizes unitary construction as a single extrusion in cross section where the flexibility of the top and bottom sheets is manages by reduced thickness and the oblique element stiffness is managed by increased thickness. Thin section hinges can also be formed to permit additional flexion point of the truss. Additionally, unitary construction may be further enhanced by use of co extrusion technology to provide material stiffness/flexibility differentiations between the structural elements of the protective cover apparatus such as rigid ribs, flexible top and bottom sheets with flexible hinges connection between these elements as described above.

To enhance purchasing desirability the protective cover flexible sheets may be adorned with team logos or brand advertising. Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of the preferred embodiment of the protective cover when attached to an automobile.

FIG. 2 is a partial cross-sectional view of the preferred construction of the protective cover, expanded to the fully deployed position.

FIG. 3 is a perspective view of an alternative embodiment of the protective cover when attached to a bay window and exterior door of a building.

FIG. 4 is a cross-sectional view of an alternative construction of the protective cover illustrating fiber reinforced flexible sheets and light weight laminate rigid elements.

FIG. 5 is a partial perspective view of the protective cover illustrating construction of multiple folding segment formations permitting folding to reduce the cover length.

FIG. 6 is an alternative embodiment in partial cross-sectional view of the protective cover formed by unitary extrusion expanded so as to illustrate alternate hinge structures for rigid top, bottom and intermediate oblique panels.

FIG. 7 is another alternate embodiment in partial cross-sectional view of the protective cover formed by unitary co extrusion of top bottom folding panels and intermediate oblique panels.

FIGS. 8A and 8B are partial cross-sectional view illustrations of an alternate construction method of the protective cover with the accordion rigid elements formed by two sided corrugated board with hinges formed by partial alternating slitting and fan folding forming the accordion structure with the stiffening corrugations perpendicular to the hinges for flexible connections for attachment to the top and bottom flexible sheets.

FIGS. 9A and 9B are partial cross-sectional view illustrations of an alternate construction method of the protective cover with the accordion rigid elements formed by thermoforming with flexible flat connections forming flexible hinges and intermediated connecting elements made rigid by corrugations perpendicular to the flexible hinges.

### DETAILED DESCRIPTION

The claimed present invention is now described with reference to the drawings. The following description of the construct details and the numerous specific details in operation and materials are set forth in order to provide a thorough disclosure and understanding of the claimed subject matter. It is evident however, that the claimed details and subject matter and preferred embodiments may be practiced in any independent combination, without departing from the spirit and scope of this invention and the claims.

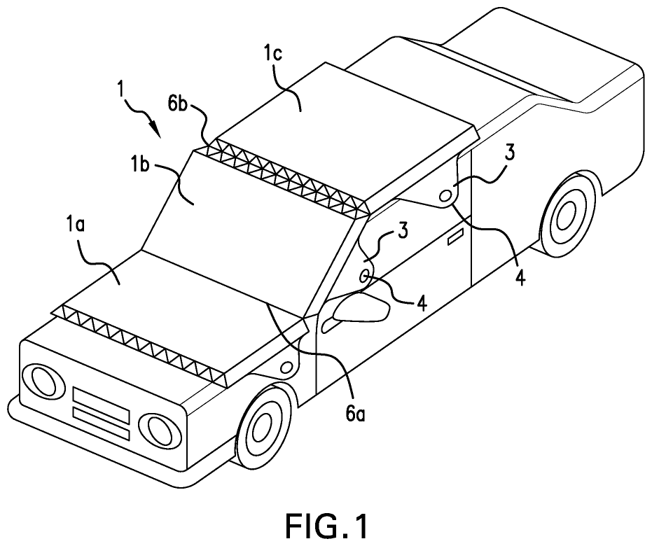

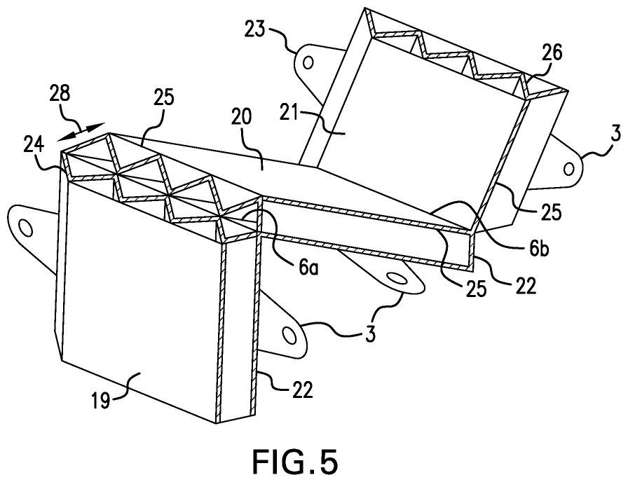

FIG. 1 illustrates the preferred embodiment of the vehicle protective cover 1 when attached to a vehicle 5 windshield. The accordion structure 2 is deployed (expanded) from side to side of the vehicle. Straps 3 may be used as illustrated attaching cover 1 to the smooth sides of the vehicle by the use of suction cups 4. Alternate attachment methods are anticipated such as elastomeric and adjustable straps with hooks constructed for attachment to the interior of the vehicle prior to closing the front doors of the vehicle. Said alternate attachment method is further advantageous as it prevents theft of the cover by locking the vehicle doors. Cover 1 is preferably formed in sections 1a, 1b and 1c with alternate interruptions (cuts) in the cover 1 forming hinge structures 6a and 6b (detailed in FIG. 5) allow for the exemplary feature of foldability in a direction perpendicular to the accordion deployment direction. This feature additionally allows the cover to conform to the vehicle front form while maintaining shorter rigid segment spanning from top 7 to bottom 8 of the vehicle windshield that further increases the protective effectiveness of the glass protecting section of the cover.

The protective cover of FIG. 1 may be advantageously extended over and around the side view mirrors of the vehicle for extended protection. Advantageously the vehicle protective cover may also be used as an exterior sun shield maintaining the glass and car interior cool. Advantageously the vehicle protective cover may also be used as a snow or ice windshield cover. Additionally, top flexible structure 9 may adorned with team or brand logos to enhance the overall appeal of the cover.

The straps 3 of FIG. 1 may be fixed or adjustable, may be made of varies materials with paint-friendly characteristics in shapes and function well known to those of ordinary skills in the art. The straps 3 of FIG. 1 alternatively may be replaced by extending the flexible sheet 10 so as to be trapped between the vehicle door and frame weather stripping as an alternate method of securing the cover to a vehicle.

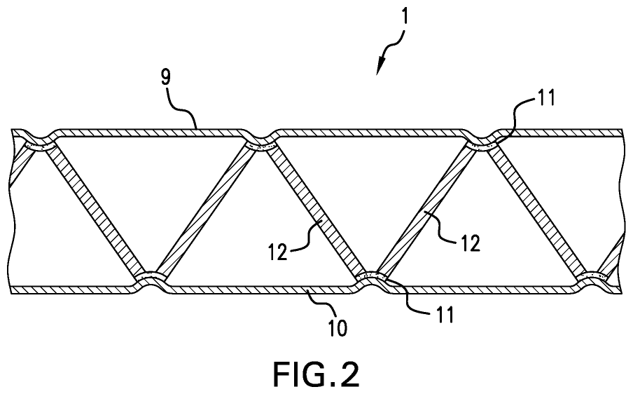

FIG. 2 illustrates a partial cross-sectional view of the preferred construction of the vehicle protective cover 1 in the deployed form, where top flexible structure 9 and bottom flexible structure 10 are affixed by adhesive 11 to oblique rigid elements 12. Preferably the effective angular apposition of the oblique elements at the fully deployed form is 60 degrees. Folding of the illustrated construction is archived by the hinge formed utilizing the flexibility of the top and bottom structures. When deployed with flexible sheets 9 and 10 in their fully extended form cover will express an effective thickness 10 providing impact protection. Notably even were the protective cover is not fully deployed any impact will force the flexible structure at the site of impact into tension achieving the fully deployed configuration by forcing oblique rigid elements 12 into compression and apart to the effective angular apposition tension thus locking the construct into the fully deployed truss resisting the impact.

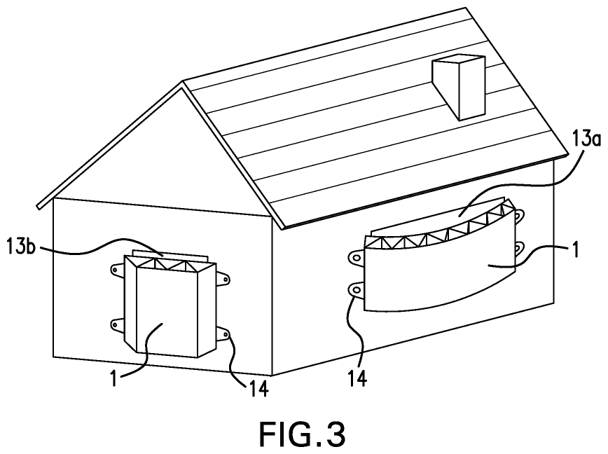

FIG. 3 illustrates an alternate embodiment of the protective cover 1 when attached to a bay window 13. The accordion structure 2 is deployed (expanded) from side to side of the window. Straps 14 may be used as illustrated attaching cover 1 to the frame of the window 13. Alternate attachment methods are anticipated such as preinstalled quick snap locking hooks. Said alternate attachment method is further advantageous as it prevents separation by wind driven separation forces it is anticipated that the deployment direction is dependent on the specific application. In the event as use as a protective cover for a doorway the cover is anticipated to be deployed from to bottom. This feature allows the cover to maintaining shorter rigid segment spanning from side to side over the vertical door posts that further increases the protective effectiveness. The top flexible structure of this embodiment may be advantageously constructed with ballistic fabric providing for both tensile strength necessary for cover stiffness and penetration resistance during impact of high velocity projectile debris.

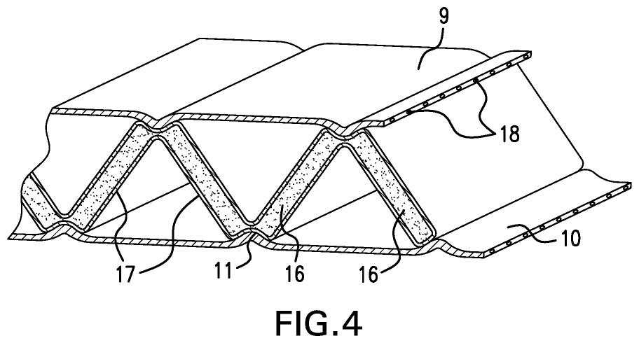

FIG. 4 is a perspective cross-sectional view of an alternate construction of FIG. 2 where the rigid elements 12 utilize a laminated structure 15 wherein the stiffness is achieved by the use of a light low stiffness core 16 and thin fabric or sheet laminates 17. Additionally, the flexible structures are constructed of thin lightweight materials with fiber reinforcement 18. Fibers 18 are preferably directed perpendicular to the direction of the oblique elements to enhance the tensile strength of the flexible structures. The laminated structure is advantageously constructed in flat sheets and subsequently scored in alternating fashion and fan folded forming the accordion structure of the truss. The thin laminate forms a flexible hinge connecting the rigid elements.

FIG. 5 is a partial perspective view of the protective cover 1 illustrating segments 19, 20 and segment 21 formations permitting foldability at hinge structures 6a and 6b. As illustrated bottom sheet 22 is common to both segment 19 and 20 while top sheet 23 and elements 24 are only integral to segment 19 thus forming hinge 6a. Similarly, top sheet 25 is common to both segment 20 and 21 while bottom sheet 26 and elements 27 are only integral to segment 21 thus forming hinge 6b. The alternate apposition of hinge formations is exemplary in the lengthwise foldability of the protective cover 1 with folded thickness 28 as it creates hinges that are independent of thickness 28.

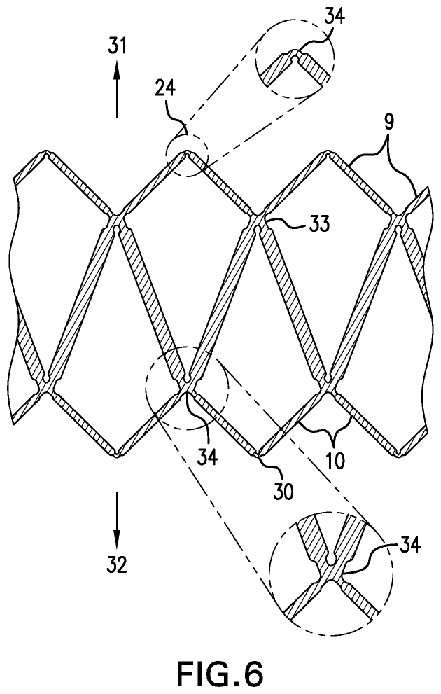

FIG. 6 is a partial cross section view illustration of the partially collapsed accordion structure of an alternate embodiment of a unitary protective cover fabricated in the formn of a single material extrusion. As illustrated the flexibility of structures 9 and 10 is achieved by providing thin solid hinge segments 29 and 30 at the mid points of their respective lengths foldably directed in an outward direction 31 and 32 respectively. Similarly, the flexibility of junctions 33 and 34 is achieved by providing thin solid material hinge florets. In the present embodiment the required stiffness is attained by managing the material properties and the thickness of the respective element. Segments 9 and 10 are subject to tensile forces thus can be constructed thin. Further reduction in thickness is achievable by providing fiber reinforcement directed perpendicular to hinge segments 29 and 30. Furthermore segments 35 are subject to compressive forces thus anticipated to be constructed thicker than segments 9 and 10.

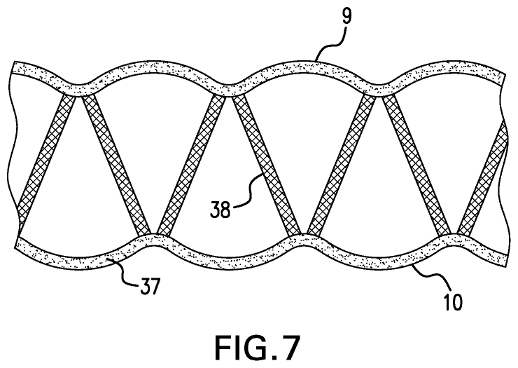

FIG. 7 is a partial cross section view illustration of the accordion structure of an alternate embodiment of a unitary protective cover fabricated in the form of a co-extrusion or a fused assembly. As illustrated structures 9 and 10 and solid hinges 36 and 37 are constructed of flexible high tensile strength soft polymer and segments 38 are constructed of high compressive strength semi rigid polymer. Preferably structures 9 and 10 have a final curved form when the cover is deployed providing additional cushioning at impact.

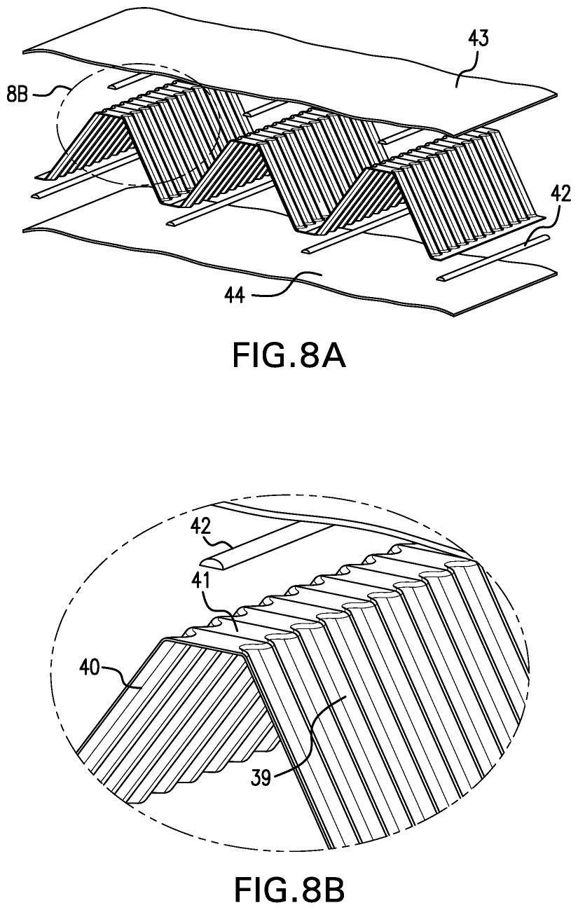

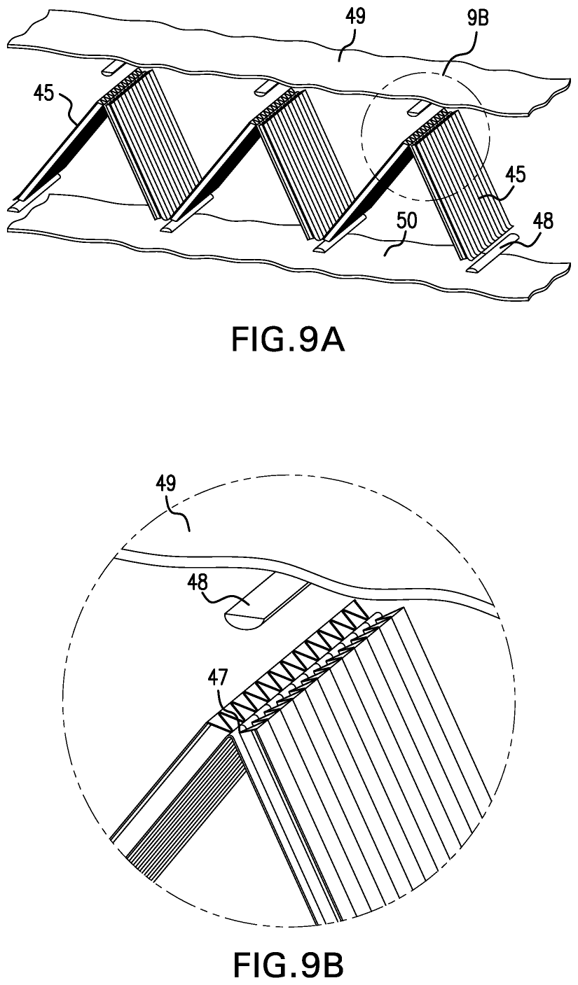

The impact resistance capabilities of the protective cover are quantified by the material characteristics, the width and cross-sectional area of the rigid elements. These elements during impact are subjected to high compressive forces and since they form a hinged truss are only subject to buckling. Laminated materials such as illustrated in FIG. 4 are typical where a soft core such as Styrofoam is laminated with thin stiffer materials forming a lightweight construction. An alternate method of increasing the stiffness of these elements without increasing the amount of material needed to construct them is by truss constructs along the length of the rigid elements. Alternate structures are compressively stiff structures wherein a thin material is fashioned such as to have a high radius of gyration. Introduction of a wave form in the thin material forming corrugations increases the stiffness. Supporting this waveform with flat sheets on one or both sides further increases the compressive stiffness of these elements. These alternate embodiments and methods of manufacture of the present apparatus are further illustrated in FIG. 8 and FIG. 9.

FIG. 8a and FIG. 8b is a perspective exploded, partial cross section detail illustrating an optional method of construction wherein the rigid elements 39 are formed by stiffening corrugations 40 and flattened connecting structures 41 constructed as such by thermoforming methods from a single elastomeric sheet. Thermoforming methods are adopted such as to form thick sheet sections in the corrugated areas of the thermoformed material with thinner sheet sections in the flattened areas advantageously forming compressively rigid ribs and flexible hinge structures. Adhesive 42 further used to attach the flattened connecting structures to the flexible sheet structures 43 and 44.

In an alternate method of construction utilizing the corrugated rib method, utilizes prefabricated corrugated board wherein the existing corrugations are compressively flattened at regular intervals, perpendicular to the corrugations and creased in an alternating fan direction forming the rigid ribs and the accordion pattern. Advantageously the prefabricated corrugated board may be constructed as single face or double faced wherein it is scored and fanfold in the perpendicular direction to the board corrugations, forming a very flexible hinge with the corrugations exposed at the score line further advantageously allowing for a stronger adhesive connection to the respective top and bottom flexible sheets.

FIGS. 9a and 9b is a perspective exploded, partial cross section detail illustrating an optional method of construction utilizing two-sided corrugated board 45. A partial slit 46 perpendicular to the board corrugations is formed along the length of the rigid elements wherein the slit extends through one of the board sides and through the corrugations wherein the opposing side remaining 47 is forming a hinge. This partial slit is repeated at regular intervals in an alternating manner and the board is further fan formed resulting in the formation of the rib truss structures. These partial slits form hinges between the rigid elements folded in an alternating pattern forming an accordion pattern. An adhesive 48 or alternate methods such as fusion methods are used to connect these hinges to the top 49 and bottom 50 flexible sheets forming the foldable truss structure.

The above detailed description includes examples of the claimed subject matter as preferred and in alternate embodiments. As it is not possible to describe all and every conceivable combination of each component size, material combinations or methods of unitary constructions for purposes of describing the claimed embodiments, one of ordinary skill in the art can recognize that many further combinations and permutations of such matter are possible

What is claimed is:

1. A protective cover apparatus 1 comprising;
a unitary truss construct having a flexible top and a flexible bottom and rigid intermediate elements integral to said top and bottom elements;
wherein when said top and bottom elements extend in tensile apposition when forcibly compressed by external impact;
wherein intermediate elements forming angular apposition to said top and bottom elements and with each other;
wherein said top and bottom elements constrain said rigid elements in the said triangular apposition further providing stiffening of said unitary truss;
wherein said truss resists said external impact wherein said truss is collapsed by forcing said semi rigid intermediate elements into parallel apposition; and
wherein said flexible top and flexible bottom flex permitting such said truss folding.

2. A protective cover construct of claim 1, wherein said flexible elements form hinge connections with said intermediate elements in the construct of a unitary truss.

3. A protective cover construct of claim 2, constructed for vehicle windshield protection deployed in a first direction along the width of said vehicle; and
wherein said rigid elements are deployed in a second direction perpendicular to said first direction.

4. A protective cover construct of claim 3, wherein said truss is formed in a unitary foldable structure having a plurality of sections,
wherein each said of sections are connected with said flexible elements to adjacent sections forming hinged connections; and
wherein said hinged connections are disposed in alternate order to said top and bottom of said flexible top elements.

5. A protective cover construct of claim of claim 3, wherein said truss is provided with a flexible attachment means fashioned to be attached to said vehicle.

6. A protective cover construct of claim 3 wherein said truss is formed in unitary foldable form having a plurality of fixation straps fashioned for secure attachment to building structures.

7. A protective cover construct of claim 5 wherein said top and bottom elements include fiber reinforcement in a direction perpendicular to said intermediate elements.

8. A protective cover apparatus forming an impact protective structure comprising;
a truss formation in a first direction and extending in uniform cross section in a perpendicular second direction;
wherein said truss is hereby formed by hinged top elements, hinged bottom elements having intermediate hinges and hinged angularly apposed intermediate elements; and
wherein said element junctions are forming the junctions of said top and said bottom and said intermediate elements.

9. The apparatus of claim 8, wherein said truss is formed in a unitary cross section; further comprising
said top and said bottom elements having a thin cross section are exemplary flexible,
said intermediate elements having of thick cross section are exemplary rigid;
and said truss elements having thin cross section forming flexible hinge junctions.

10. The apparatus of claim 9, wherein said truss is formed in a welded cross section further comprising;
said top and said bottom elements are formed by a thin flexible material;
said intermediate elements having of thick cross section are exemplary rigid;
and welded to said flexible material forming flexible hinge junctions.

11. The apparatus of claim 10, wherein said truss is formed in multiple materials wherein;
said top and said bottom elements are formed by thin flexible polymer;
and said intermediate elements are formed by rigid polymer; and
wherein said polymers are co-extruded.

12. The apparatus of claim 8, wherein said top and said bottom elements contain high tensile strength fiber reinforcement elements preferably directed along said first direction.

13. A protective cover construct of claim 12, wherein said truss is formed in unitary foldable form having a plurality of sections;
wherein each said section are flexibly connected with said adjacent section forming hinged connections; and
wherein said hinged connections are disposed in alternate order to said top and bottom of said flexible top elements.

14. A protective cover construct of claim of claim 13, wherein said truss is provided with flexible attachment means fashioned to be attached to a vehicle.

15. A protective cover construct of claim 13, wherein said truss is formed in unitary foldable form having a plurality of fixation straps fashioned for attachment to building structures.

16. A method of manufacturing of said first and second alternate method of construction wherein said rigid rib and said connecting structures are formed by an over molding operation to existing top and bottom flexible structures.

17. A method of manufacturing of a protective cover apparatus forming an impact protective structure; the steps of which comprise:
wherein the connecting structures are formed by an over molding operation to existing top and bottom flexible structures and existing rigid rib structures;
wherein said connecting structures are formed of flexible polymer;
wherein said connecting structures forming an exterior soft rib advantageously providing cover cushioning contact with the protected surfaces.

18. A method of construction of a unitary collapsible truss structure cover which is foldable in a direction perpendicular to said truss structure and intended for protection of fragile structures, the steps of which comprise;
a flexible top and flexible bottom structure,
a rigid intermediate angularly apposed structures wherein rigid structures are lengthwise interrupted forming a first and second segment;
a top flexible structure which is interrupted at the level of a rigid structure interruption;
a top flexible interruption aligned and directed perpendicular to a rigid structure interruption;
wherein said bottom flexible structure is continuous to said first and second segments;
wherein said bottom flexible structure is extending further than said rigid structures at regular intervals forming straps fashioned for a secure attachment to cover said protected structures.

19. A method of forming collapsible truss having top and bottom flexible fabric structures and rigid intermediate ribs, the steps of which comprise;
said ribs constructed by corrugated laminates; wherein corrugations are directed perpendicular to the length of said ribs wherewith rib width is formed by interruptions of said corrugations forming folding hinges;
said folding hinges forming said corrugated laminate in accordion manner having top and bottom alternating hinges and permanently attaching top and bottom fabric to said accordion top and bottom hinges spaced, such that in the partially extended accordion and top and bottom structures being fully extended forming a truss.

20. A method of constructing an impact resisting cover, the steps of which comprise,
a top and bottom flexible sheet extending in a first and perpendicular second direction;
an intermediate accordion structure formed by continuous material ribs having hinges formed by a reduced material cross section of said rib material connecting said ribs and extending in said first direction;
wherein said hinges are additionally integrally connected to said top and bottom sheets.

21. The method of claim 20, wherein said material ribs have a laminated cross section; wherein said reduced cross section is constructed as a partial slit perpendicular to the laminate face further forming said hinges.

22. The method of claim 20, wherein said ribs have a corrugated cross section with corrugations directed in said second direction having said reduced cross section constructed flat further forming said hinges.

23. The method of claim 20, wherein said ribs have a laminated corrugated cross section with corrugations directed in said second direction;
wherein said reduced cross section having a partial slit perpendicular to said corrugated cross section forming said hinges.
